(19) United States
(12) Patent Application Publication
(10) Pub. No.: US 2006/0090995 A1
(43) Pub. Date: May 4, 2006

(54) System and method for carrying out a discontinuous rectification or reaction

(75) Inventors: Georg Fieg, Mettman (DE); Thomas Kapala, Ratingen (DE)

Correspondence Address: COGNIS CORPORATION;PATENT DEPARTMENT, 300 BROOKSIDE AVENUE, AMBLER, PA, 19002, US

(73) Assignee: Cognis IP Management GmbH, Duesseldorf (DE)

(21) Appl. No.: 10/526,956

(22) PCT Filed: Aug. 29, 2003
(86) PCT No.: PCT/EP03/09605

§ 371 Date: Sep. 30, 2005

(30) Foreign Application Priority Data
Sep. 7, 2002 (DE) 102 41 482.3

(51) Int. Cl. B01D 3/34

(52) U.S. Cl. 203/29; 203/100; 202/158

(57) ABSTRACT

The invention is an apparatus and process for batch rectification or reaction with batch distillation. The apparatus is a rectifying column alone or mounted on a batch reactor. The rectifying column having a collector for the downflowing column liquid arranged to collect liquid flowing down the column and a valve arrangement to direct the flow selectively away from the column or to the column at a time when downflowing product is being removed from the column. The column is operated at total reflux until the product reaches a required purity then the liquid flow from the collector is directed away from the column and the product recovered.

This invention relates on the one hand to a plant for carrying out batch rectification in a rectifying column or for carrying out a chemical reaction in a batch reactor surmounted by a rectifying column, the rectifying column being designed for operation under total reflux and comprising at least one column section for material transfer, at least one product vessel below the column section for collecting and temporarily storing the liquid which has flowed downwards through the column section and at least one other product vessel for collecting and temporarily storing the head product.

The column section for material transfer may differ in design according to the nature of the rectifying column. Plate and packed columns and special constructions, such as wetted-wall and trickle columns, and also rectifying columns with rotating internals (spray columns) and other types of construction may be used. The invention is not limited to a particular type of column. However, a packed column with built-in packings is preferred, as will be explained in the following.

In conventional batch distillation or rectification, the individual fractions are successively distilled off overhead in order of volatility. The individual fractions are preferably removed in a time-constant concentration as the reflux ratio gradually increases. The disadvantage here is that the reflux ratio has to be carefully controlled and that operating errors during production can seriously impair the purity already achieved in the collected product. The last batch of product entering the product tank can affect the quality of the contents so seriously that the entire contents of the tank have to be worked up again. This is particularly the case when very high product purities have to be, or are intended to be, achieved.

To solve this problem, it is known that the batch rectification can be carried out under total reflux and that product vessels can be provided at the head of the column and, optionally, in the middle, too, for the purpose of collecting the liquid accumulating at the particular point of the column and releasing it after a certain time. Accordingly, these product vessels are designed for temporary storage of the liquid accumulating at the particular point of the column.

A few years ago, this multivessel batch distillation was the subject of an in-depth study. However, the experiments involved in that study were only conducted on a laboratory scale and pilot scale (Warter, Michael: “Batch-Rektifikation mit Mittelbehälter”, Fortschr.-Ber. VDI Reihe 3 No. 686, VDI Verlag Düsseldorf, 2001).

The first advantage of this so-called “cyclic method of operation” is that the best possible theoretical separation efficiency can be obtained for the plant used. This can be graphically demonstrated very easily with the known McCabe-Thiele diagram for binary mixtures because, in this case, the linear working curve coincides with the diagonal, so that the best separation efficiency is achieved. Accordingly, multivessel batch distillation is particularly suitable for the production of high-purity products. The advantage here is that there is no need for strategies for the current change in the reflux ratio, as is normally the case with conventional batch rectification.

The second advantage of the cyclic method of operation is that the production of specific product qualities can be carried out very safely with multivessel batch distillation. In the cyclic method, no product leaves the system balance space to begin with because there is no further transport into the product tanks. Only when the product qualities satisfy the predetermined quality criteria is product pumped into the product tanks. In this way, the possibility of operator errors during production is greatly limited. This is particularly important in the production of products expected to satisfy very stringent purity requirements because, in the event of an operator error in conventional batch rectification, the last batch of product entering the product tank can critically affect the quality of the high-purity product hitherto collected in the tank. This disadvantage is avoided by the described cyclic procedure.

Other advantages of the cyclic method of operation lie in the simultaneous production of several marketable products over all the product vessels, in a saving of time and in possible savings of energy by virtue of the heat-integrated system and, hence, in a reduction in the production costs.

A special version of multivessel batch distillation is a column with only one upper product vessel (head/distillate vessel) and with the base of the column as another product vessel. In this case, only two products, namely the head and bottom products, can of course be simultaneously produced under total reflux.

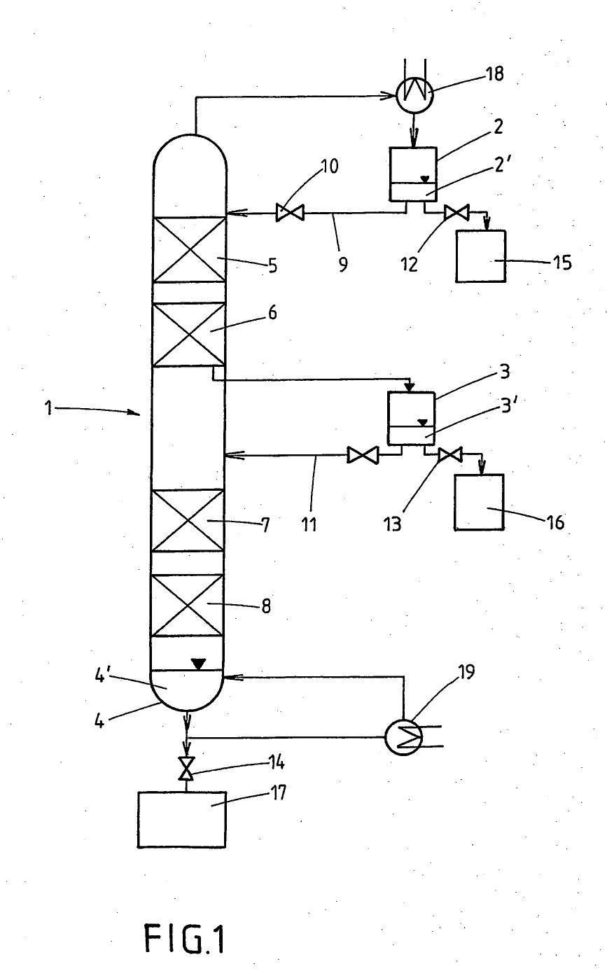

However, serious problems arise in the cyclic method of operation where it is to be carried out an industrial production scale, as explained in the following. In the known rectifying column 1 shown in FIG. 1, a concentration profile is naturally developed. At least two components and usually several components are present in each of the individual column sections. This means that, for example in the lower column section with the packings 7,8, one or more components of the second product 3′ and third product 4′ must always be present. The same applies to all other column sections. These components form the liquid holdup in the column which is made up of the holdup on the packing elements and packings. In addition, another type of holdup is important, above all in columns with modern packings, namely the holdup in the collectors and distributors not shown in FIG. 1. The holdup in the collectors in particular is crucially important.

As already mentioned, the cyclic mode of operation with a multivessel structure is distinguished by the fact that the individual vessels are emptied and the entire holdup of the product vessel is pumped into the production tanks. If this is carried out for all product vessels (the base of a rectifying column being taken as a product vessel), the energy supply to the evaporator system is automatically interrupted during emptying. In view of the greatly reduced volume of liquid at the base, the circulating stream in forced-circulation evaporators, for example in falling-film evaporators, or in natural circulation evaporators breaks up and can no longer be maintained. The hydrodynamic conditions in the column are thus seriously disrupted. As a result of these events, the pressure profile in the column collapses and the hydrodynamic equilibrium between the ascending vapor phase and the downwardly flowing liquid phase can no longer be maintained. The outcome of this is that the entire holdup flows into the individual product vessels and impairs product quality. This is of particular relevance to high product purities because, in this case, the high purity requirements in the individual product vessels can no longer be satisfied. Accordingly, where the known process and the known plant are used, high-purity products cannot be produced by multivessel batch distillation on an industrial production scale.

If multivessel batch distillation is carried out on a laboratory scale, this problem generally does not arise on termination of the process. In this case, the primary concern is not a high product yield, but rather the production of product patterns of predetermined high purity. Accordingly, the bottom vessel is only emptied to a relatively small extent in order to establish the product pattern, the product remaining in the bottom vessel being present in a sufficient quantity so that the supply of heat is maintained and the above-mentioned problem does not arise on termination of the process on an industrial production scale. The same applies to the production of product samples by partial emptying of the other product vessels.

Accordingly, the problem addressed by the invention was to make it possible—in a plant of the type mentioned at the beginning—reliably to obtain high product purities and yields in the operation of the plant on an industrial production scale.

In a plant of the type mentioned at the beginning, the solution to the problem stated above as provided by the invention is characterized in that an arrangement is provided for selectively guiding the liquid into the product vessel located below the column section or past that product vessel.

In this way, the plant can be operated as follows: first, the rectifying column is operated under total reflux, the arrangement mentioned guiding the liquid into the product vessel where the liquid is collected and temporarily stored and, finally, is returned to the column. If a steady operating state of the plant is reached, the product quality in the product vessels meeting predetermined requirements, the product vessels can be completely emptied without the holdup flowing downwards into the product vessels and impairing product quality because the arrangement mentioned is now reversed and guides the liquid flowing back past the product vessels.

In one particular embodiment, the column section containing the holdup comprises at least one built-in packing and/or at least one built-in plate. In other words, a modern packed column and optionally a plate column are preferred.

The above-mentioned arrangement for selectively guiding the liquid can differ in its design, depending in particular on the nature of the product vessel. If the product vessel below the column section is a bottom vessel or a batch reactor, a collector is arranged between the lowermost column section, for example the lowermost packing of the rectifying column, and the bottom vessel or the batch reactor and is connected at its outlet to an auxiliary vessel and to the bottom vessel or to the batch reactor and the arrangement for selectively guiding the liquid comprises a first valve assembly. If the bottom vessel or the batch reactor is to be emptied, this first valve assembly is actuated in such a way that the holdup from the lowermost material transfer zone no longer flows into the bottom vessel or into the batch reactor, but into the auxiliary vessel and, hence, does not impair the high quality, more particularly the high purity, of the bottom product.

Basically, the downwardly flowing liquid can flow completely through the auxiliary vessel mentioned and from there into the bottom of the column, even when the column is operated under total reflux. In a preferred embodiment, however, the downwardly flowing liquid flows directly from the lowermost material transfer zone into the bottom vessel during the first phase of the process, a valve being provided at the outlet of the collector located below the lowermost packing. To terminate the process, this valve is closed and another valve is opened to guide the liquid through a bypass into the auxiliary vessel. The same applies to a batch reactor surmounted by a rectifying column. Accordingly, it is expressly proposed that the collector be connected via the first valve assembly on the one hand to the auxiliary vessel and, on the other hand, to the bottom vessel or to the batch reactor. The first valve assembly may consist of an arrangement of several valves or of a single multiway valve.

As already mentioned, the plant according to the invention may be used not only for physically separating mixtures, but also for carrying out chemical reactions, more particularly as a batch reactor surmounted by a rectifying column. In this case, the bottom vessel corresponds to a batch tank reactor, for example a stirred tank reactor. A known plant comprising a stirred tank reactor surmounted by a rectifying column is described, for example, in EP 0 464 045 B1 (Henkel KGaA). In this case, however, the rectifying column is not designed for multivessel batch distillation.

In order to produce a high-quality product accumulating in the middle part of the column in accordance with the invention, it is proposed for the plant according to the invention that the liquid flowing downwards in the middle column section can be guided by a second valve assembly into a second product vessel, of which the outlet is connected to the lower column section, or into a bypass pipe leading around the second product vessel. In contrast to the bottom vessel, the additional vessel provided in this embodiment does not act as a collecting vessel for the holdup, but instead as a product vessel which is connected via suitable valves to the column, i.e. on the one hand to the outlet of the collector and, on the other hand, to the inlet of the underlying distributor. Of key importance here is the bypass pipe around the second product vessel through which the holdup flows on termination of the process in order not to contaminate the holdup which has already collected in the second product vessel.

Similarly, several product vessels of this type can be arranged along the column, but at different levels, i.e. below different central column sections, the contents of the product vessels being identically protected against the holdup flowing down on completion of the process.

So far as the production of the head product in the plant according to the invention is concerned, it is further proposed that the product vessel for the head product, i.e. the distillate vessel, be connected to the head of the column via a feed pipe, more especially with a condenser, and a reflux pipe.

Finally, the present invention also relates to a process for carrying out a rectification and/or a reaction in a plant of the type according to the invention.

In the process according to the invention, the problem stated above is solved by first carrying out the process under total reflux and guiding the liquid for temporary storage into the product vessels and then, i.e. when the predetermined or desired specification, more particularly the required purity, is reached, past the product vessels and emptying the product vessels.

Further advantages and several embodiments of the invention are described in detail in the following with reference to the accompanying drawings, wherein:

FIG. 1 schematically illustrates a known multivessel batch distillation plant.

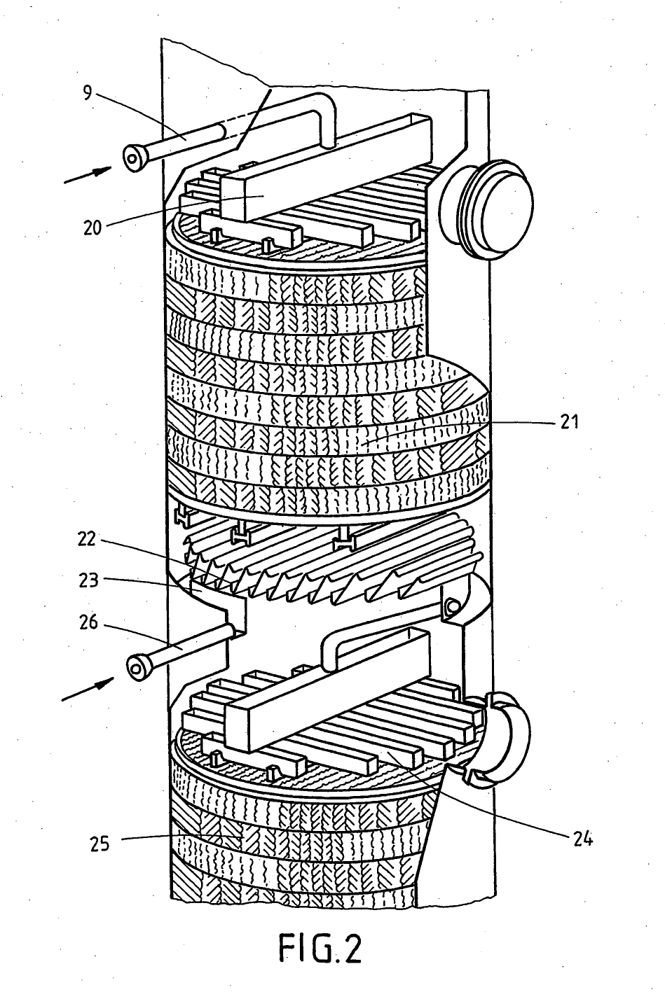

FIG. 2 is a perspective view of the middle part of a modern packed column with a known packing (Sulzer packing).

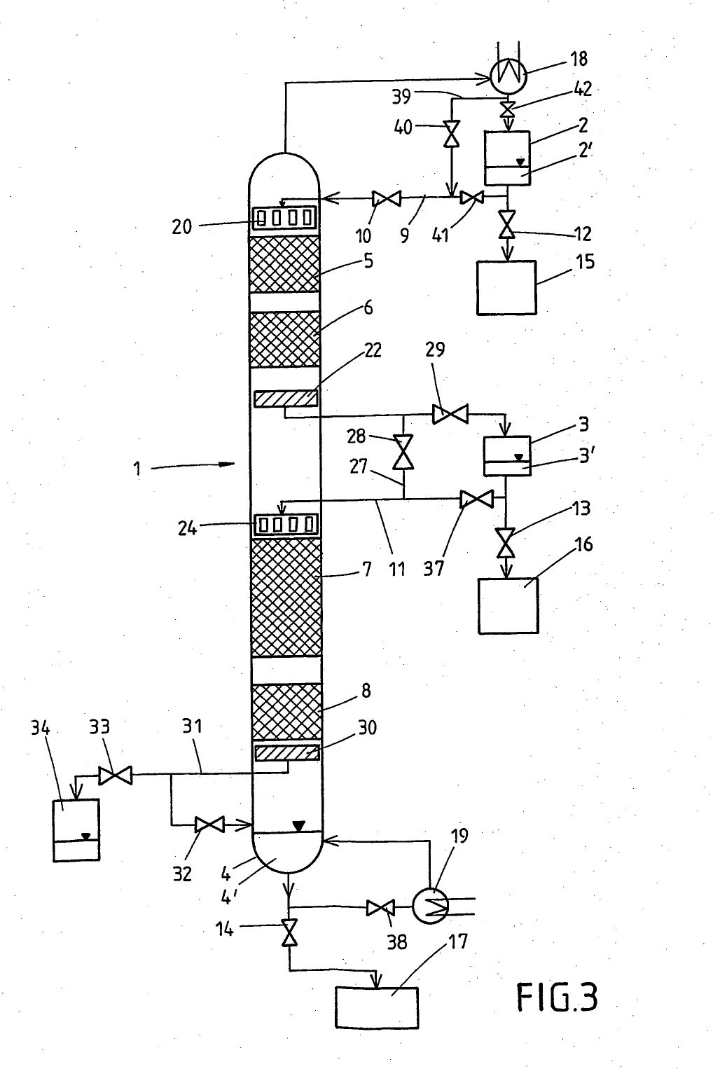

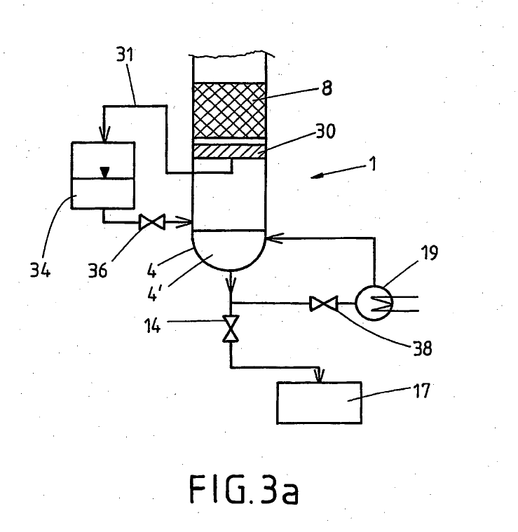

FIG. 3 schematically illustrates a first embodiment of a multivessel batch distillation plant according to the invention.

FIG. 3a shows the lower part of the plant illustrated in FIG. 3 in another variant according to the invention.

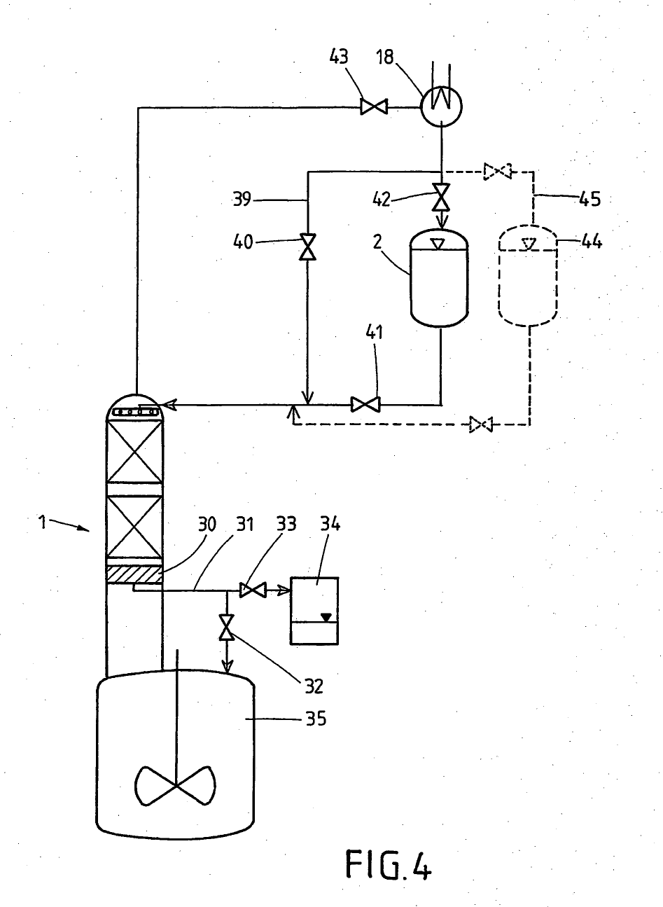

FIG. 4 schematically illustrates another embodiment of a plant according to the invention comprising a reactor surmounted by a rectifying column.

In all the drawings, the same reference numerals have the same meaning and, accordingly, may be explained only once.

One example of a known multivessel batch distillation plant is schematically illustrated in FIG. 1. Several product vessels 2, 3 are arranged along a standard batch rectifying column 1. The bottom of the column is regarded as a product vessel 4 for the bottom product. The liquid flowing down through the packings 5, 6, 7, 8 in the column 1 is removed from the column and guided into a corresponding product vessel 2, 3, 4. The products themselves are denoted by the reference numerals 2′ for the head product, 3′ for the product temporarily stored in the middle vessel 3 and 4′ for the bottom product. Several product vessels may also be arranged in the middle part of the column. After a predetermined volume of liquid has collected in the vessels 2, 3, a liquid stream is then removed from the vessels 2, 3 and returned to the column 1 through the pipes 9 (with valve 10) and 11.

The column is thus operated under total reflux because no product stream is removed from the individual product vessels 2, 3, 4 and guided into a product tank. After a transition period, steady states are spontaneously established in all the product vessels 2, 3, 4. This means that the quality of the product in the individual product vessels is not subjected to any more changes as a function of time and remains substantially constant. For this reason, this type of rectification is also known as “cyclic rectification” to distinguish it from the conventional batch rectification procedure.

If the quality achieved satisfies the purity requirements for the individual products, the second phase of the process is initiated, i.e. the valves 12, 13, 14 are opened and the products 2′, 3′, 4′ are removed from the individual product vessels 2, 3, 4 and guided into the product tanks 15, 16, 17.

If the product quality in the individual product vessels 2, 3, 4 does not correspond to the required product quality, more particularly the required purity, the product volumes in the product vessels 2, 3, 4 are slightly changed by suitable changes to the process parameters, a new steady state is allowed to develop and a decision is then made as to further procedure.

A condenser 18 known per se at the head of the column 1 and the bottom heater 19 known per se—for example in the form of a forced-circulation evaporator or a natural circulation evaporator—are also shown in FIG. 1.

For a better understanding of the significance of the volume of liquid stored in the collectors of a rectifying column, which leads to serious problems on termination of the known multivessel batch distillation process, FIG. 2 shows part of a conventional rectifying column. The reflux from the condenser 18 is fed through the pipe 9 to a distributor 20 and, from there, trickles uniformly downwards through the packing 21. The volumes of liquid issuing from the underneath of the packing 21 are collected by obliquely positioned metal “lamellae”, i.e. by the collector 22, and are fed through an annular passage 23 to another distributor 24 which distributes the liquid uniformly over the top of the underlying packing 25. The lamellar collector 22 may be, for example, a collector of the SLR type from Sulzer. Another pipe 26 which opens into the annular passage 23 is provided in the middle part of the column for introducing the liquid feed.

A plant according to the invention is schematized in FIG. 3 which shows a rectifying column 1 for separating a liquid mixture.

Besides the elements known per se, which were explained in the description of the plant shown in FIG. 1, the new features and elements according to the invention will now be discussed in detail. Instead of a single product vessel 3, several product vessels 3 may of course be arranged along the column in the middle part thereof. According to the invention, certain arrangements are provided to prevent the contents of the product vessels 3, 4 from being mixed with the volumes of liquid on the packings 5, 6, 7, 8, in the collectors 22, 30 and the distributors 20, 24.

On the one hand, an auxiliary pipe 27 is installed parallel to the product pipe 11 in the region of the product vessel 3 and is designed to be shut off by a valve 28. The product vessel 3 can be safeguarded against the liquid flowing down in the column 1 by another valve 29. In addition, an auxiliary valve 37 is arranged between the outlet of the product vessel 3 and the distributor 24. In the steady state established in the plant when the specified product quality is reached in the product vessel 3, the valves 29 and 37 are closed and the valve 28 is opened, so that the liquid flows directly from the collector 22 to the distributor 24 and not into the product vessel 3. After the valve 13 has been opened, the product vessel 3 is emptied into the product tank 16.

On the other hand, a different type of arrangement is shown in the lowermost region of the column and prevents the bottom product from mixing with the holdup on the overlying packings 7, 8 and in the distributor 24 and the column internals situated further above. The proposed diversion of the liquid stream in the middle part of the column as a reflux stream from the column directly back into the column without the detour via the product vessel cannot of course be accomplished here because, in this case, the liquid stream would pass into the bottom of the column where it would contaminate the bottom product 4′. Instead, an additional collector 30 is installed below the lowermost packing 8. The collector 30 collects the entire liquid stream which would otherwise pass directly into the bottom vessel 4.

Until the steady state is established in all the product vessels, the entire liquid stream, which leaves the last packing section 8 and is collected by the collector 30, is guided through the pipe 31 and the opened valve 32 into the bottom vessel 4. After the steady state has been established in all the product vessels and shortly before all the products vessels and also the bottom vessel 4 are emptied, the liquid flowing from the outlet of the collector 30 is guided through the pipe 31 and an opened valve 33 into an auxiliary vessel 34 which collects the holdup flowing downwards through the column. The valve 32 meanwhile is of course closed to prevent contamination of the bottom product 4′ by the holdup. When the process is next carried out, the liquid mixture collected in the auxiliary vessel 34 can again be mixed with the new feed and worked up again. An advantage here is that no product losses have to be accepted, so that particularly economical operation is guaranteed.

Alternatively, but not preferably, the auxiliary vessel 34 may also be installed in such a way (FIG. 3a) that the entire volume of liquid released from the collector 30 always flows first into the auxiliary vessel 34. After the steady operating state has been established, the auxiliary vessel 34 is first emptied into the bottom vessel 4 and the valve 36 is then closed. The bottom vessel 4 is then emptied into the product tank 17 by opening of the valve 14 and closing of the valve 38, as in the preferred variant shown in FIG. 3.

In addition, an auxiliary pipe 39 with a valve 40 at the head of the column (FIG. 3) is advantageous. In the steady operating state of the plant, the auxiliary pipe 39 is brought into operation by opening of the valve 40 and closing of the valves 41, 42, so that the contents of the product vessel 2 are protected against any disturbances that could contaminate its composition.

The invention also encompasses the special case of multivessel batch distillation where a column is provided with only one distillate vessel 2 and a bottom product vessel 4 as the product vessel, but no so-called middle vessel(s). Such arrangements are typified in particular by batch reactors known per se surmounted by a column as schematized, for example, in FIG. 4 in an embodiment of the invention. Here, the product vessel 4 for the bottom product is in the form of a stirred tank reactor 35. The other product vessel in FIG. 4 is the distillate vessel 2. By virtue of the advantages mentioned, the plant illustrated in FIG. 4 is operated under total reflux. The attached rectifying column is also used to remove the excess educt after the reaction. One example of such a reaction is the production of an ester from an organic acid and an alcohol as described, for example, in the above-cited EP 0 464 045 B1. In many cases, the useful component is a product of relatively low volatility from which the low-boiling constituents are to be removed.

In order to protect the contents of the reactor, which in many cases contains the useful component, from the holdup of the column 1 after termination of the reaction, an arrangement corresponding to FIG. 3 is provided in the bottom region. After the low-boiling constituents collected in the product vessel 2 have been removed, the valve 32 is closed and the valve 33 opened, so that the holdup is guided from the column 1 through the collector 30 and the pipe 31 not into the stirred tank reactor 35, but instead through the valve 33 into the auxiliary vessel 34.

The plant shown in FIG. 4 is particularly suitable for high-purity bottom products which would suffer losses of quality by mixing with the liquid stream flowing down from the column 1. This leads to the further advantage that the need for a distillation step to remove the low-boiling constituents emanating from the holdup from the bottom product is eliminated.

The procedure in the head region of the plant shown in FIG. 4 during the reaction is explained in detail in the following with reference to the general reaction:
A+B [symbol] C+D
This reaction may be, for example, an esterification reaction where A=alcohol, B=acid, C=ester and D=water. If—in the interests of simplicity—it is assumed that A, B, C and D are completely miscible, a homogeneous mixture is present. The column is used for continuously removing water (component D) from the reaction mixture with minimal losses of components A, B and C. The reaction equilibrium in the reactor is thus very favorably influenced. In order to minimize investment costs, the height of the column is kept to a minimum in practice. Since the greatest separation efficiency is achieved with total reflux, the following procedure is adopted (FIG. 4), the valves 41, 42, 43 being open and the valve 40 closed.

Alternatively, the reaction may be the following:
A+B [symbol] C
where a low-boiling product C is to be removed. The objective here is to obtain a “pure” product C in the distillate vessel 2. To this end, the valves 41, 42, 43 are first opened and the valve 40 is closed. When substantially the entire quantity of product C has collected in the product vessel 2 and unwanted secondary products of the reaction are gradually distilled off and threaten also to enter the product vessel 2, the auxiliary pipe 39 is brought into operation by opening of the valve 40 and the valves 41, 42 are closed. The valve 43 of course remains open. In this way, the contents of the product vessel 2 are protected against secondary products removed by distillation and against the excess of component A or B.

An alternative to the auxiliary pipe 39 would be switching over in known manner to another parallel vessel 44 by means of another auxiliary pipe 45. The other vessel 44 and the other auxiliary pipe 45 with the valves are shown in chain lines in FIG. 4.

After termination of the reaction A+B [symbol] C+D, the water of reaction D which has collected in the vessel 2 is removed—if it has not already been removed from the vessel 2 during the reaction—and the excess of component A or B is distilled off from the reaction mixture in order to obtain the high-purity useful product C. The excess of the educt component A or B is collected in the product vessel 2 which acts as a distillate receiver. It is desirable to achieve a high concentration (purity) of the contents of the product vessel 2 because this component is generally returned to the reactor and re-used for the next batch. A high concentration enables a high volume/time yield to be achieved in the reactor with the next batch.

During removal of the excess of component A or B by distillation after termination of the reaction, the valves 41, 42, 43 are opened and the valve 40 is closed.

After the desired composition has been reached in the product vessel 2, the following actions are taken in the order listed:
1. The valves 41, 42 are closed and the valve 40 in the auxiliary pipe 39 is opened, the valve 43 of course remaining closed.
2. The valve 33 is then opened and the valve 32 closed in order to protect the useful product.
3. The contents of the batch reactor 35, i.e. the useful product C, are pumped into a product tank (not shown in FIG. 4).
4. The contents of the auxiliary vessel 34 are pumped back to the batch reactor 35.
5. The contents of the product vessel 2 are also pumped back to the batch reactor 35.
6. The next batch is started with the measured introduction of starting components A and B.

To sum up: the plant shown in FIG. 4 consists of a reactor 35 and a column 1. The first phase of the process comprises a reaction coupled with a distillation, for example an esterification with removal of water by distillation. The second phase of the process comprises only a distillation, for example removal of the excess of educts by distillation. Accordingly, in the second phase, the plant behaves in the same way as in conventional batch distillation. The difference here lies in the unusually large bottom vessel which is formed by the reactor. In conventional batch distillation, however, the bottom vessel is not a reactor.

### EXAMPLE

An example of the process according to the invention was carried out in the plant shown in FIG. 3. Two Sulzer BX packings each with a height of 1 m were arranged in the 70 mm diameter column. Each of these packings corresponded to 5 to 6 theoretical plates. The column was operated with a head pressure of 10 to 20 mbar, the pressure loss over the column being 4 to 8 mbar. The bottom temperature was 130 to 140° C. A conventional electromagnetic reflux divider (Normag) was used instead of a collector.

2.9 kg of a test mixture of fatty alcohols with the following composition were used:

| | |
|---|---|
| C6: | 24.8% |
| C8: | 26.0% |
| C10: | 49.2% |

A steady state was reached after 2.5 hours. In other words, the compositions of the three products, i.e. the head product, the middle product and the bottom product, as measured with a gas chromatograph, remained constant.

Before emptying, the product vessels were protected in accordance with the invention against the downwardly flowing holdup. The experimentally obtained product compositions were as follows:

| | |
|---|---|
| C6: | 98.8% |
| C8: | 98.1% |
| C10: | 99.5%, |

the three products being analyzed by gas chromatograph.

These high product purities, which were obtained on only 5 to 6 theoretical plates, are attributable to the mode of operation with total reflux, which guarantees the highest possible system separation efficiency, and to the arrangement according to the invention for protecting the products against the downwardly flowing holdup.

### LIST OF REFERENCE NUMERALS

1 batch rectifying column
2 product vessel for 1st product
2′ head product
3 product vessel for 2nd product
3′ 2nd product
4 product vessel for bottom product (3rd product), bottom vessel
4′ bottom product
5 packing (column section)
6 packing (column section)
7 packing (column section)
8 packing (column section)
9 pipe for distillate (condensate)
10 valve
11 pipe
12 valve
13 valve
14 valve
15 product tank for 1 st product
16 product tank for 2nd product
17 product tank for 3rd product (bottom product)
18 condenser
19 bottom heater
20 distributor
21 packing
22 collector
23 annular passage
24 distributor
25 packing
26 feed pipe
27 auxiliary pipe
28 valve
29 valve
30 collector
32′ pipe
32 valve
33 valve
34 auxiliary container
35 stirred tank reactor, batch reactor
36 valve
27 auxiliary valve
38 valve
39 auxiliary pipe
40 valve
41 valve
42 valve
43 valve
44 additional container
45 other auxiliary pipe

1-7. (canceled)

8. An apparatus for carrying out batch rectification in a rectifying column or for carrying out a chemical reaction and rectification in a batch reactor surmounted by a rectifying column, the rectifying column adapted for operation under total reflux, comprising at least one rectifying column section for material transfer; at least one column underflow product vessel for collecting and temporarily storing a liquid which flows downward through the rectifying column section; an overhead product vessel for collecting and temporarily storing an overhead product; wherein, an arrangement is provided for selectively guiding liquid, flowing down the rectifying column section, into the underflow product vessel or away from the underflow product vessel.

9. The apparatus of claim 8, wherein, the column section comprises at least one packing section or at least one rectifying plate.

10. The apparatus of claim 8, wherein, the underflow product vessel comprises a bottom vessel or a batch reactor; a collector is arranged between a lowermost column section and the bottom vessel or the batch reactor to collect liquid which flows down the column, the collector is connected at its outlet to an auxiliary vessel the outlet of the auxiliary vessel is connected to the bottom vessel or to the batch reactor via a valve which selectively controls the liquid flow to the bottom vessel or the batch reactor.

11. The apparatus of claim 8, wherein the underflow product vessel comprises a bottom vessel or a batch reactor; a collector is arranged between a lowermost column section and the bottom vessel or the batch reactor to collect liquid which flows down the column, the collector is connected at its outlet to an auxiliary vessel via a first valve and to the bottom vessel or batch reactor via a second valve.

12. The apparatus as claimed in claim 9, wherein a middle column collector is arranged to collect liquid which flows downward in a middle column section; a second valve assembly arranged to selectively guide the collected liquid into a second product vessel having an outlet which is connected to a lower column section, or to a bypass pipe arranged to bypass the liquid around the second product vessel.

13. The apparatus as claimed in claim 8, wherein the overhead product vessel is connected to a head of the column via a feed pipe, a condenser, and a reflux pipe.

14. A process for carrying out a rectification or a reaction with rectification in the apparatus of claim 8, wherein, the process is initially carried out under total reflux with a liquid flowing down a column section guided for temporary storage into product vessels and when the composition of liquid product in the product vessels achieves a required purity, the liquid flowing down the column section is guided away from the product vessels and at least a portion of the liquid product is removed from the product vessels.

15. The apparatus of claim 9, wherein, the underflow product vessel comprises a bottom vessel or a batch reactor; a collector is arranged between a lowermost column section and the bottom vessel or the batch reactor to collect liquid which flows down the column, the collector is connected at its outlet to an auxiliary vessel the outlet of the auxiliary vessel is connected to the bottom vessel or to the batch reactor via a valve which selectively controls the liquid flow to the bottom vessel or the batch reactor.

16. The apparatus of claim 9, wherein the underflow product vessel comprises a bottom vessel or a batch reactor; a collector is arranged between a lowermost column section and the bottom vessel or the batch reactor to collect liquid which flows down the column, the collector is connected at its outlet to an auxiliary vessel via a first valve and to the bottom vessel or batch reactor via a second valve.

17. The apparatus of claim 9, wherein a middle column collector is arranged to collect liquid which flows downward in a middle column section; a second valve assembly arranged to selectively guide the collected liquid into a second product vessel having an outlet which is connected to a lower column section, or to a bypass pipe arranged to bypass the liquid around the second product vessel.

18. The apparatus of claim 9, wherein the overhead product vessel is connected to a head of the column via a feed pipe, a condenser, and a reflux pipe.

19. The apparatus of claim 10, wherein a middle column collector is arranged to collect liquid which flows downward in a middle column section; a second valve assembly arranged to selectively guide the collected liquid into a second product vessel having an outlet which is connected to a lower column section, or to a bypass pipe arranged to bypass the liquid around the second product vessel.

20. The apparatus of claim 11, wherein a middle column collector is arranged to collect liquid which flows downward in a middle column section; a second valve assembly arranged to selectively guide the collected liquid into a second product vessel having an outlet which is connected to a lower column section, or to a bypass pipe arranged to bypass the liquid around the second product vessel.

21. The apparatus of claim 11, wherein the overhead product vessel is connected to a head of the column via a feed pipe, a condenser, and a reflux pipe.

22. The apparatus of claim 12, wherein the overhead product vessel is connected to a head of the column via a feed pipe, a condenser, and a reflux pipe.
